(19) United States
(12) Patent Application Publication
(10) Pub. No.: US 2010/0218091 A1
(43) Pub. Date: Aug. 26, 2010

(54) Apparatus and method for extracting thumbnail of contents in electronic device

(75) Inventor: Sang-Kyung Lee, Anyang-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/660,169

(22) Filed: Feb. 22, 2010

(30) Foreign Application Priority Data
Feb. 23, 2009 (KR) 10-2009-0014771

(51) Int. Cl. G06F 17/00

(52) U.S. Cl. 715/255

(57) ABSTRACT

A method and apparatus for extracting a thumbnail of contents in an electronic device are provided. The method includes setting a reference image and a thumbnail extraction reference, automatically executing contents, acquiring a plurality of picture images generated by the automatic execution of the contents, at each preset time, comparing the reference image with the plurality of picture images and selecting one image from the plurality of picture images meeting the thumbnail extraction reference, and storing, as a thumbnail, the selected image and state information corresponding to the selected image.

### CROSS-REFERENCE TO RELATED APPLICATION(S) AND CLAIM OF PRIORITY

The present application claims is related to and priority under 35 U.S.C. §119(a) to a Korean Patent Application filed in the Korean Intellectual Property Office on Feb. 23, 2009 and assigned Ser. No. 10-2009-0014771, the contents of which are herein incorporated by reference.

### TECHNICAL FIELD OF THE INVENTION

The present invention relates to an apparatus and method for extracting a thumbnail of contents in an electronic device. More particularly, the present invention relates to an apparatus and method for automatically executing application type contents and extracting a thumbnail in an electronic device.

### BACKGROUND

The development of Internet technology results in a gradual increase in the sharing and distributing of User Created Contents (UCC) on the Internet. That is, users share and distribute various contents such as a document, music, a photograph, a moving picture, a game, and so forth. Particularly, in recent years, a large portion of the contents is increasingly occupied by application type contents created using an Application Programming Interface (API) provided in a variety of platforms such as a game and the like. Here, the application type contents represent an executable program constituted of a logic and data like a general application.

Commonly, users display what kind of contents their own contents are, what content their own contents contain, and so forth, to distribute or share their own contents with other users.

FIG. 1 illustrates a way of extracting a thumbnail of moving picture contents according to the conventional art, and FIG. 2 illustrates a way of displaying application type contents according to the conventional art. As illustrated in FIG. 1, in the case of moving picture contents, a user displays the moving picture contents to other users through a way of splitting the moving picture contents by a predetermined time and generating a bookmark thumbnail. On the contrary, as illustrated in FIG. 2, in the case of application type contents such as a game, a user displays what contents the application type contents are to other users using one image or a small number of images that can represent the application type contents. As described above, in the case of the application type contents, there is an inconvenience that a manufacturer should execute a game in real time, and select and capture a picture intended for displaying to other users one by one. Also, there is a limit that it is not enough to display a few pictures of the application type contents in making other users exactly aware of what content the application type contents contain. Also, unlike the moving picture contents, the content of the application type contents is flexible, and there are execution paths corresponding to the number of cases depending on an input variable from a user. This causes a problem that, unlike the moving picture contents, it is difficult to apply a way to split contents by a predetermined time and extract a bookmark thumbnail.

### SUMMARY OF THE INVENTION

An aspect of the present invention is to substantially solve at least the above problems and/or disadvantages and to provide at least the advantages below. Accordingly, one aspect of the present invention is to provide an apparatus and method for extracting a thumbnail of contents in an electronic device.

Another aspect of the present invention is to provide an apparatus and method for automatically executing application type contents and extracting a thumbnail in an electronic device.

The above aspects are achieved by providing an apparatus and method for extracting a thumbnail of contents in an electronic device.

According to one aspect of the present invention, a method for extracting a thumbnail of contents in an electronic device is provided. The method includes setting a reference image and a thumbnail extraction reference, automatically executing contents, acquiring a plurality of picture images generated by the automatic execution of the one or more contents at each of a preset time, comparing the reference image with each of the plurality of picture images and selecting one image from the plurality of picture images meeting the thumbnail extraction reference, and storing, as a thumbnail, the selected image and state information corresponding to the selected image.

According to another aspect of the present invention, an apparatus for extracting a thumbnail of contents in an electronic device is provided. The apparatus includes a condition controller, a contents executor, a comparator, and a storage unit. The condition controller sets a reference image and a thumbnail extraction reference. The contents executor automatically executes one or more contents, and acquires a plurality of picture images generated by the automatic execution of the contents at each of a preset time. The comparator compares the reference image with each of the plurality of picture images and selects one image from the plurality of picture images meeting the thumbnail extraction reference. The storage unit stores, as a thumbnail, the selected image and state information corresponding to the selected image.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a way of extracting a thumbnail of moving picture contents according to the conventional art;

FIG. 2 illustrates a way of displaying application type contents according to the conventional art;

FIG. 3 illustrates a schematic construction of an electronic device according to the present invention;

FIG. 4 illustrates a detailed construction of a thumbnail extractor of FIG. 3 according to the present invention;

FIG. 5 illustrates a way of extracting a thumbnail based upon the number of times an event occurs in an electronic device according to an exemplary embodiment of the present invention;

FIG. 6 illustrates a way of extracting a thumbnail based upon the number of cases that are dependent on an input variable in an electronic device according to an exemplary embodiment of the present invention;

FIG. 7 illustrates a way of extracting a thumbnail dependent on a plurality of execution paths in an electronic device according to an exemplary embodiment of the present invention;

FIG. 8 illustrates a result of extracting a thumbnail of contents in an electronic device according to an exemplary embodiment of the present invention; and

FIG. 9 illustrates an operation of extracting a thumbnail in an electronic device according to an exemplary embodiment of the present invention.

### DETAILED DESCRIPTION OF THE INVENTION

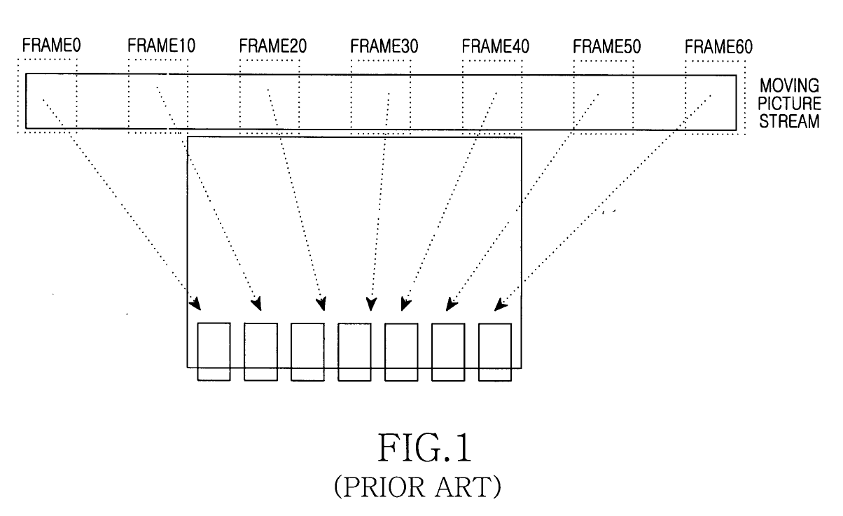

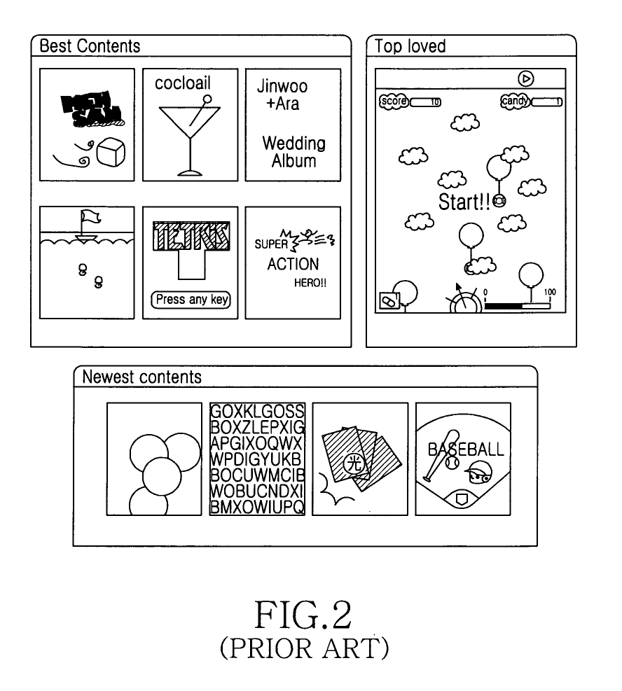

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The following description is made for an apparatus and method for automatically executing application type contents and extracting a thumbnail in an electronic device according to an exemplary embodiment of the present invention. In the following description, contents mean an application file executed by a virtual machine or a player that is mounted in an electronic device such as a portable terminal or the like. The contents are executed independently with no association with other applications or contents. In the following description, a thumbnail means the inclusion of an image of a predetermined size for displaying contents and information on the image. The image of the predetermined size for displaying the contents is called a thumbnail image.

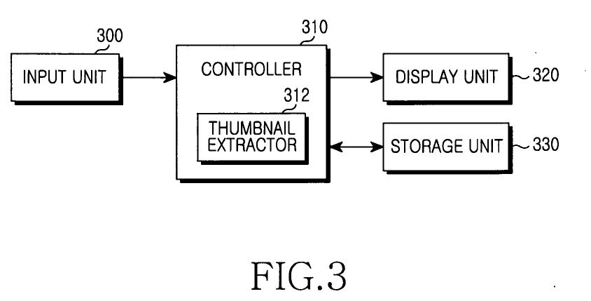

FIG. 3 illustrates a schematic construction of an electronic device according to the present invention.

Referring to FIG. 3, the electronic device includes an input unit 300, a controller 310, a display unit 320, and a storage unit 330. Particularly, according to the present invention, the controller 310 includes a thumbnail extractor 312.

The input unit 300 includes character keys, numeric keys, and a plurality of function keys and provides data corresponding to a key pressed by a user to the controller 310. According to the present invention, the input unit 300 receives a specific thumbnail selected by the user and provides the specific thumbnail to the controller 310.

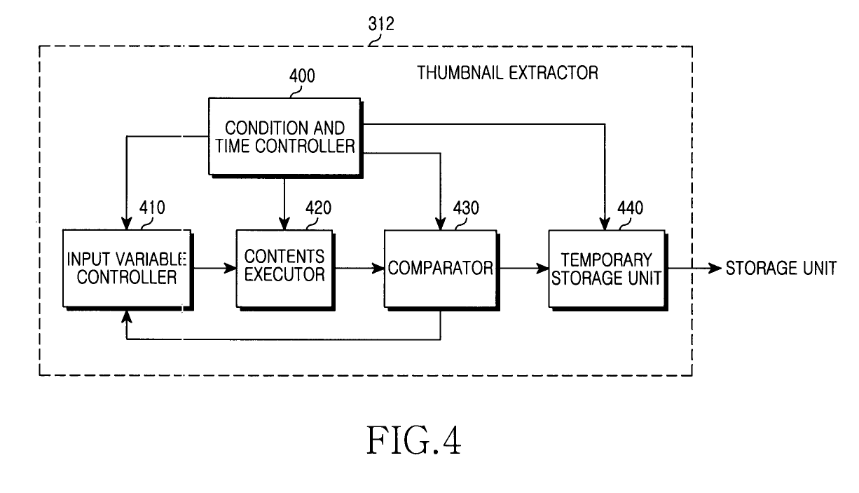

The controller 310 processes a general operation of the electronic device. According to the present invention, the controller 310 includes the thumbnail extractor 312, and thus, the controller 310 controls and processes a function of automatically executing application type contents, extracting a thumbnail, and storing the extracted thumbnail in the storage unit 330. As illustrated in FIG. 4, the thumbnail extractor 312 includes a condition and time controller 400, an input variable controller 410, a contents executor 420, a comparator 430, and a temporary storage unit 440. So, the thumbnail extractor 312 extracts and stores a thumbnail meeting a preset condition at predetermined intervals of time based upon the number of cases that are dependent on an input variable, and stores state information corresponding to the extracted thumbnail together. Here, the state information corresponding to the thumbnail represents information required to make the contents be in the same conditions as those conditions at the time when the thumbnail was extracted. The state information includes time information of the time when the thumbnail is extracted, an attribute value of contents dependent on an input variable, and the like. Also, the input variable is a value that is input for the sake of contents execution and can vary depending on the situation and time. For example, assuming that the contents are a car racing game, the input variable can be a value that is input to move a car. Accordingly, the number of cases that are dependent on the input variable means the number of ways of executing the contents depending on the input variable. For instance, assuming that the contents are a car racing game, a car can go straight, turn left, turn right, or stop at a specific place depending on the input variable. These four ways become the number of cases.

An operation of the thumbnail extractor 312 is described below in detail with reference to FIG. 4.

The thumbnail extractor 312 sets and stores an initial reference image of contents through the condition and time controller 400. The thumbnail extractor 312 sets a range of an input variable, a thumbnail extraction reference, and an interval of time of thumbnail extraction. At this time, the thumbnail extractor 312 provides the set range of the input variable to the input variable controller 410, provides the thumbnail extraction reference to the comparator 430, and instructs the contents executor 420 to provide the comparator 430 with contents execution picture images that are generated during a corresponding duration of time at the set intervals of time of thumbnail extraction.

The input variable controller 410 receives a range of an input variable from the condition and time controller 400 and, within the received range, determines a value of an input variable provided to the contents executor 420. Also, if a thumbnail image is selected in the comparator 430, the input variable controller 410 receives an input variable corresponding to the thumbnail image and determines a value of the input variable provided to the contents executor 420.

The contents executor 420 automatically executes contents based upon the number of cases that are dependent on an input variable provided from the input variable controller 410. Under the control of the condition and time controller 400, the contents executor 420 provides the comparator 430 with contents execution picture images generated within a corresponding duration of time at preset intervals of time of thumbnail extraction and state information corresponding to the generated picture images. Here, the contents executor 420 automatically executes the contents based upon the number of cases that are dependent on the input variable and thus, provides the comparator 430 with a contents execution picture image for each of the number of cases and state information corresponding to the execution picture image.

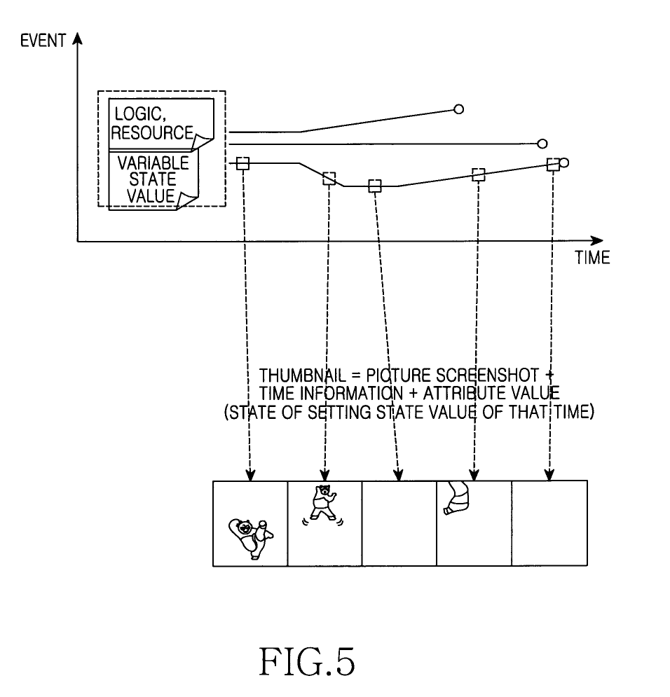

The comparator 430 receives an initial reference image and a preset thumbnail extraction reference from the condition and time controller 400, compares images received from the contents executor 420 with the initial reference image, and selects one image meeting the thumbnail extraction reference. Here, the thumbnail extraction reference can be quantifiable information such as the number of activated objects, positions of objects, a dispersion of motion, and the like. That is, as illustrated in FIG. 5, upon execution, each content generates various events depending on an input variable and, accordingly, has variable state values. These variable state values can be set as reference values for extracting a thumbnail. For instance, upon execution, each content can vary the number of activated objects depending on the input variable, and therefore, the number of activated objects can be set as the thumbnail extraction reference. In this case, the comparator 430 can determine the number of activated objects of each image provided from the contents executor 420, compare the determined number of activated objects with the number of activated objects of an initial reference image, and select an image with the greatest difference as a thumbnail image.

If the thumbnail image is selected, the comparator 430 stores the selected thumbnail image and state information corresponding to the selected thumbnail image in the temporary storage unit 440. Also, the comparator 430 sets the selected thumbnail image as a reference image, uses the set reference image at the next thumbnail image extraction, and provides an input variable corresponding to the selected thumbnail image to the input variable controller 410.

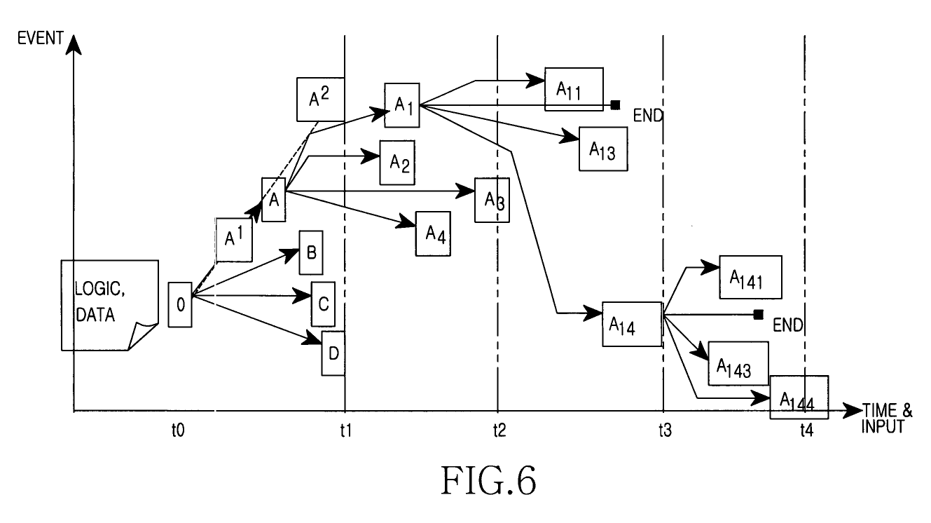

For instance, as illustrated in FIG. 6, it is assumed that an image (0) of a time (t0) is a reference image and images (A¹, A, A², B, C, and D) are generated as a result of executing corresponding contents during a predetermined duration of time (t0 to t1). On the assumption that a preset condition is a dispersion of motion, the comparator 430 can determine dispersion of motions between the image (0) and the images (A¹, A, A², B, C, and D), respectively, and then, select the image (A) having the greatest dispersion of motion as a thumbnail image. At this time, the comparator 430 stores information on a time at which the image (A) is generated, an input variable of the time, an attribute value of each object, and so forth, along with the thumbnail image. The comparator 430 provides the input variable for the image (A) to the input variable controller 410 such that the contents are executed on the basis of the image (A) starting from a time (t1). Here, it can be appreciated from FIG. 6 that images (A1, A2, A3, and A4) are generated when the contents are executed on the basis of the image (A) during a duration of ‘t1’ to ‘t2’.

The temporary storage unit 440 receives a thumbnail image and state information corresponding to the thumbnail image from the comparator 430, maps the received thumbnail image and state information to specific contents, and temporarily stores the mapping result. Under the control of the condition and time controller 400, if an end of an event of thumbnail extraction is detected, the temporary storage unit 440 binds, by one execution path, the thumbnail images and corresponding state information mapped to the specific contents and provides the binding result to the storage unit 330.

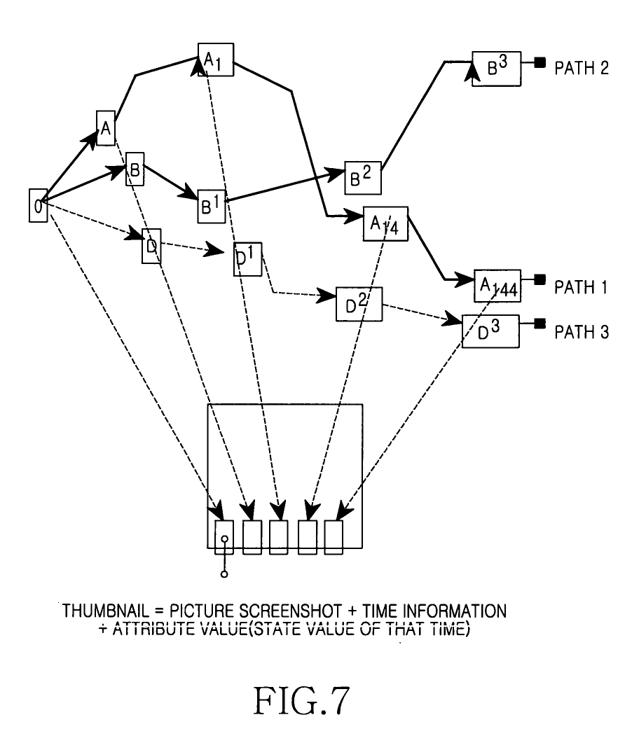

At a time an event of displaying information on contents occurs, the controller 310 controls a function for displaying on the display unit 320 thumbnail images extracted through the thumbnail extractor 312 and, at a time it is detected that a specific thumbnail image is selected by a user through the input unit 300, the controller 310 allocates the contents state information corresponding to the thumbnail image and executes the contents such that the contents can be executed in the same conditions as those conditions at the time when the selected thumbnail image was extracted. Also, as illustrated in FIG. 7, the controller 310 can extract thumbnails for a plurality of execution paths from one piece of content through the thumbnail extractor 312, and select a thumbnail for one execution path meeting a preset final reference among the plurality of execution paths as a thumbnail for the contents.

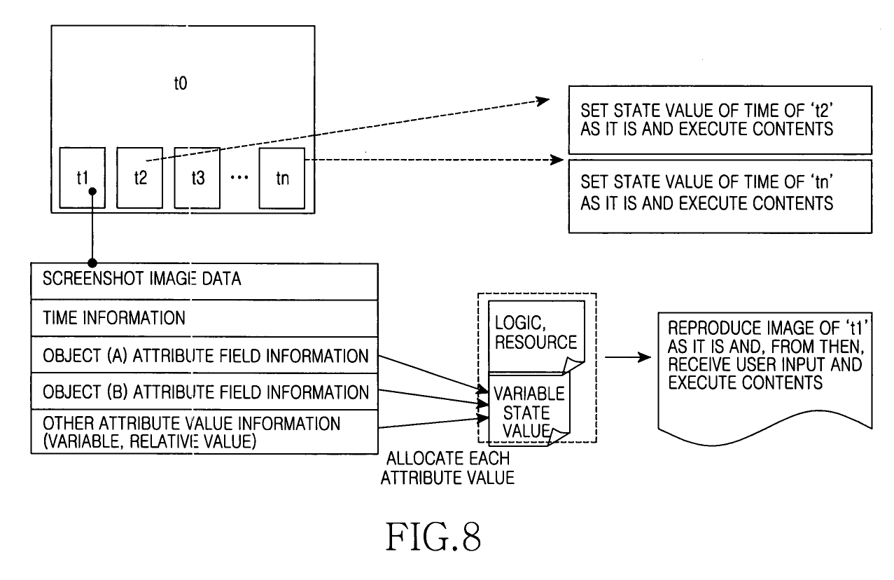

The display unit 320 displays state information generated during an operation of the electronic device, numerals, characters, and the like. Particularly, the display unit 320 displays thumbnail images extracted from contents under the control of the controller 310. At this time, as illustrated in FIG. 8, the display unit 320 can display an initially set reference image (t0) as a basic image, and display thumbnail images (t1, t2, t3, . . . , tn) extracted at predetermined intervals of time in a predetermined position on the background of the initially set reference image (t0). The thumbnail images (t1, t2, t3, . . . , tn) each are mapped to state information of the time of thumbnail extraction such that, at a time when a specific thumbnail image is selected by the controller 310. the contents can be executed in the same conditions as those conditions at the time when the specific thumbnail was extracted.

The storage unit 330 stores a program for a general operation of the electronic device and various kinds of data. According to the present invention, the storage unit 330 stores a thumbnail image extracted from the thumbnail extractor 312 and state information corresponding to the thumbnail image.

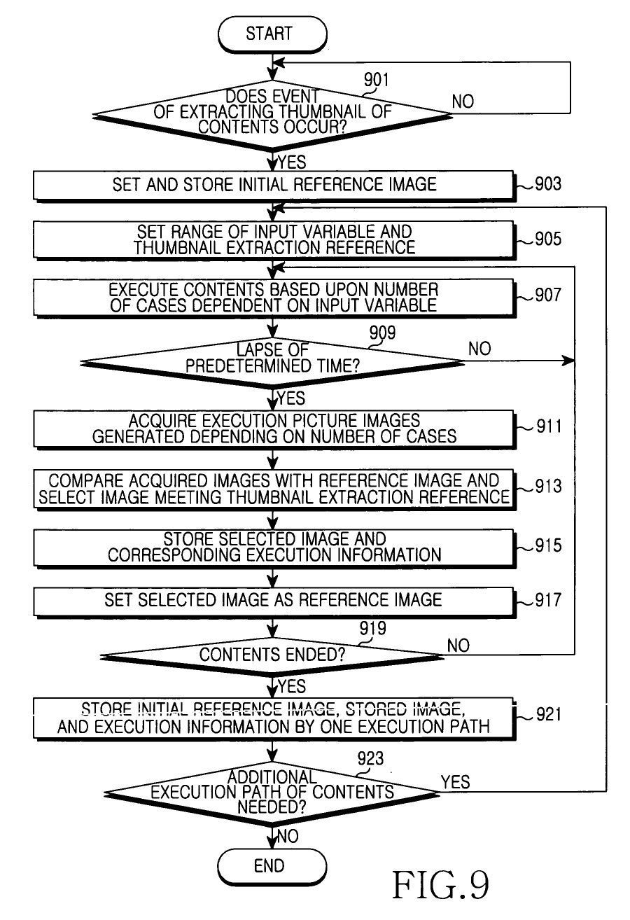

FIG. 9 illustrates an operation procedure of extracting a thumbnail in an electronic device according to an exemplary embodiment of the present invention.

Referring to FIG. 9, if an event of extracting a thumbnail of specific contents occurs in step 901, the electronic device proceeds to step 903 and sets and stores an initial reference image of the contents. Then, in step 905, the electronic device sets a range of an input variable and sets a thumbnail extraction reference. Here, the initial reference image can be set as an image displayed as a start picture of the contents, and the thumbnail extraction reference can be set as a quantifiable value among state values that are variable at the time of contents execution. For example, the thumbnail extraction reference can be set as one or more pieces of information among quantifiable information such as number of activated objects, positions of objects, a dispersion of motion, and so forth.

Then, the electronic device proceeds to step 907 and executes the contents based upon the number of cases that are dependent on the input variable. Then, the electronic device proceeds to step 909 and checks if the execution is performed during a preset predetermined duration of time. Here, the predetermined duration of time can be also set in step 903 or step 905 before the contents execution.

If the execution is not performed during the predetermined duration of time, the electronic device returns to step 907. If the execution is performed during the predetermined duration of time, the electronic device proceeds to step 911 and acquires a plurality of images of execution pictures resulting from the contents execution dependent on the number of cases during the predetermined duration of time.

After that, in step 913, the electronic device compares the acquired plurality of images with a reference image and selects an image satisfying the thumbnail extraction reference. For example, when the thumbnail extraction reference is the number of activated objects, the electronic device can determine the number of activated objects for the acquired plurality of images, compare the determined number of objects with the number of activated objects of the reference image, and select an image having the greatest difference as a thumbnail image. Then, in step 915, the electronic device stores the selected image and state information on the selected image, and in step 917, the electronic device sets the selected image as a reference image. Here, the state information on the image means information required to make the contents be in the same conditions as those conditions at the time when the image was generated. The state information includes time information of the time when the image is generated, an attribute value of contents dependent on an input variable, and so forth.

Then, in step 919, the electronic device checks if the contents execution ends, that is, if the contents are all executed up to a preset execution duration. If the contents are not executed up to the preset execution duration, the electronic device returns to step 907 and repeatedly performs subsequent steps. Otherwise, if the contents are executed up to the preset execution duration, the electronic device proceeds to step 921 and binds the initial reference image, the stored image, and the state information on the stored image by one execution path and stores the binding result.

After that, in step 923, the electronic device checks if there is a need for an additional execution path for the contents. That is, the electronic device checks if there is a need to additionally extract a thumbnail image having an execution path different from the execution path stored in step 921. If there is the need for the additional execution path, the electronic device returns to step 905 and resets the range of the input variable and the thumbnail extraction reference, and repeatedly performs subsequent steps. Here, resetting the range of the input variable and the thumbnail extraction reference is for extracting a thumbnail of a different execution path.

Otherwise, if there is no need for the additional execution path, the electronic device terminates the procedure according to the exemplary embodiment of the present invention.

The above description is made, for example, for a case that contents have various execution paths depending on an input variable. However, in some cases, the input variable is not enough for the contents to have the various execution paths. In this case, these contents can have various execution paths by arbitrarily generating an event realized in a logic of contents or arbitrarily controlling attribute values of objects.

An exemplary embodiment of the present invention has an effect of, by automatically executing application type contents and extracting a thumbnail meeting a preset condition in consideration of the number of cases dependent on an input variable in an electronic device, being capable of helping other users to easily understand the contents and facilitating distribution and sharing of the contents and, by making it possible to execute an application from a time at which a thumbnail is extracted, being capable of omitting a troublesome manipulation for shifting to a specific time of execution. Also, the exemplary embodiment of the present invention can provide various cases to a contents creator to allow the contents creator to easily find an error, and provide a chance to perform a test by time.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for extracting a thumbnail of contents in an electronic device, the method comprising:
setting a reference image and a thumbnail extraction reference;
automatically executing one or more contents;
acquiring a plurality of picture images generated by the automatic execution of the contents at each of a preset time;
comparing the reference image with each of the plurality of picture images and selecting one image from the plurality of picture images meeting the thumbnail extraction reference; and
storing, as a thumbnail, the selected image and state information corresponding to the selected image.

2. The method of claim 1, wherein the thumbnail extraction reference is one of a plurality of state values that are variable at the time of the contents execution.

3. The method of claim 1, wherein the thumbnail extraction reference is at least one of a number of activated objects, positions of objects, and a dispersion of motion.

4. The method of claim 1, wherein the state information is information required to make the contents be in the same conditions as those conditions at the time when the selected image was generated.

5. The method of claim 4, wherein the state information comprises at least one of time information of the time when the selected image is generated, an input variable, and an attribute value of contents dependent on the input variable.

6. The method of claim 1, wherein the automatic execution of the contents is performed based at least partly upon the number of cases that are dependent on a variation of an input variable.

7. An apparatus for extracting a thumbnail of contents in an electronic device, the apparatus comprising:
a condition controller configured to set a reference image and a thumbnail extraction reference;
a contents executor configured to automatically execute one or more contents, and to acquire a plurality of picture images generated by the automatic execution of the contents at each of a preset time;
a comparator configured to compare the reference image with each of the plurality of picture images and to select one image from the plurality of picture images meeting the thumbnail extraction reference; and
a storage unit configured to store, as a thumbnail, the selected image and state information corresponding to the selected image.

8. The apparatus of claim 7, wherein the thumbnail extraction reference is one of a plurality of state values that are variable at the time of the contents execution.

9. The apparatus of claim 7, wherein the thumbnail extraction reference is at least one of a number of activated objects, positions of objects, and a dispersion of motion.

10. The apparatus of claim 7, wherein the state information is information required to make the contents be in the same conditions as those conditions at the time when the selected image was generated.

11. The apparatus of claim 10, wherein the state information comprises at least one of time information of the time when the selected image was generated, an input variable, and an attribute value of contents that are dependent on the input variable.

12. The apparatus of claim 7, wherein the contents executor configured to automatically execute the contents based at least partly upon a number of cases that are dependent on a variation of an input variable.

13. An electronic device comprising:
a condition controller configured to set a reference image and a thumbnail extraction reference;
a contents executor configured to automatically execute one or more contents, and to acquire a plurality of picture images generated by the automatic execution of the contents at a predetermined interval;
a comparator configured to compare the reference image with each of the plurality of picture images to generate a difference value for each of the plurality of picture images and to select one image from the plurality of picture images having a difference value that is closest to the thumbnail extraction reference; and
a storage unit configured to store the selected image and state information corresponding to the selected image as a thumbnail.

14. The device of claim 13, wherein the thumbnail extraction reference is one of a plurality of state values that are variable at the time of the contents execution.

15. The device of claim 13, wherein the thumbnail extraction reference is at least one of a number of activated objects, positions of objects, and a dispersion of motion.

16. The device of claim 13, wherein the state information is information required to make the contents be in the same conditions as those conditions at the time when the selected image was generated.

17. The device of claim 16, wherein the state information comprises at least one of time information of the time when the selected image was generated, an input variable, and an attribute value of contents that are dependent on the input variable.

18. The device of claim 13, wherein the contents executor configured to automatically execute the contents based at least partly upon a number of cases that are dependent on a variation of an input variable.

19. The device of claim 18 further comprising an input variable controller configured to:
receive a range for the input variable from the condition controller, and
determine a value for the input variable within the received range.

20. The device of claim 13 further comprising a display configured to display the thumbnail.
